(19) United States
(12) Patent Application Publication
(10) Pub. No.: US 2022/0303632 A1
(43) Pub. Date: Sep. 22, 2022

(54) SYSTEMS AND METHODS FOR AUTOMATICALLY ADJUSTING PLAYBACK OF MEDIA CONTENT ITEMS

(71) Applicant: Meta Platforms, Inc., Menlo Park, CA (US)

(72) Inventor: Sammy El Ghazzal, Oberengstringen (CH)

(21) Appl. No.: 17/204,336

(22) Filed: Mar. 17, 2021

(51) Int. Cl. H04N 21/472; G06N 20/00; H04N 21/2387; H04N 21/845; H04N 21/8405; H04N 21/466

(52) U.S. Cl. CPC H04N 21/47217; G06N 20/00; H04N 21/2387; H04N 21/8456; H04N 21/8405; H04N 21/466

(57) ABSTRACT

Systems, methods, and non-transitory computer-readable media can determine context information associated with a media content item accessible to a user. One or more segments of the media content item can be determined. At least one segment of the media content item to be provided for presentation and a playback speed for the at least one segment can be determined based at least in part on a machine learning model that evaluates the context information and the one or more segments.

### FIELD OF THE INVENTION

The present technology relates to processing of media content items. More particularly, the present technology relates to computerized techniques for automatically adjusting playback of media content items.

### BACKGROUND

People often utilize computing devices (or systems) for a wide variety of purposes. Users can use their computing devices to, for example, interact with one another, access content, share content, and create content. In some cases, content items can include postings (or posts) from users participating in a content provider system, such as a social networking system. The postings may include text and media content items, such as images, graphical interchange formats (GIFs), videos, and audio. The postings may be published to the content provider system for consumption by others.

### SUMMARY

Various embodiments of the present technology can include systems, methods, and non-transitory computer-readable media configured to determine context information associated with a media content item accessible to a user. One or more segments of the media content item can be determined. At least one segment of the media content item to be provided for presentation and a playback speed for the at least one segment can be determined based at least in part on a machine learning model that evaluates the context information and the one or more segments.

In some embodiments, the machine learning model can output a score, a confidence score, and a playback speed for each segment of the one or more segments.

In some embodiments, the one or more segments can be ranked based on their respective scores and confidence scores.

In some embodiments, an indicator indicating a playback location associated with the at least one segment can be provided during playback of the media content item. In response to a user interaction, the playback of the media content item can be transitioned to the playback location indicated by the indicator.

In some embodiments, the media content item can be provided for presentation to the user at a playback location corresponding to the at least one segment.

In some embodiments, the one or more segments can be determined based on at least one of objects, scenes, environments, concepts, or themes depicted in the media content item.

In some embodiments, the one or more segments can be determined based on keywords or pauses in the media content item.

In some embodiments, the context information can be determined based on a source of the media content item.

In some embodiments, the context information can be determined based on chats or content feeds from which the media content item is accessible to the user.

In some embodiments, the playback speed is determined based in part on playback speed at which other users previously played segments of the media content item.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system, including an example content sharing module, according to an embodiment of the present technology.

FIG. 2 illustrates an example playback determination module, according to an embodiment of the present technology.

FIG. 3A illustrates an example functional block diagram, according to an embodiment of the present technology.

FIG. 3B illustrates another example functional block diagram, according to an embodiment of the present technology.

FIGS. 4A-4B illustrate example diagrams, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

People often utilize computing devices (or systems) for a wide variety of purposes. Users can use their computing devices to, for example, interact with one another, access content, share content, and create content. In some cases, content items can include postings (or posts) from users participating in a content provider system, such as a social networking system. The postings may include text and media content items, such as images, graphical interchange formats (GIFs), videos, and audio. The postings may be published to the content provider system for consumption by others.

In general, a content provider system, such as a social networking system, can provide users with access to various media content items. These media content items can include, for example, images, videos, audio, and/or other content. For example, a user can share a video by posting a link to the video through the content provider system. In this example, the link to the video can be accessed by other users (e.g., connections) to view the video. In many instances, videos shared by users may contain some portions of content that are interesting to users and other portions that are less interesting or not interesting. For example, a content publisher may post (or share) a 5-minute long video with a caption “Check out this cute dog!”. In this example, only 30 seconds of the 5-minute long video relate to the cute dog referenced in the caption. As a result, users that access the video with the intention of seeing the cute dog may need to watch (or scrub through) the video until the relevant 30-second portion of the video is located. Alternatively, users can randomly jump to various times in the video to search for the cute dog. As such, under conventional approaches, users that consume videos are provided a suboptimal experience where videos are provided without regard for individual user preferences. Users are burdened with painstakingly locating relevant portions of videos, which can be especially difficult with lengthy videos. Therefore, conventional approaches can discourage users from accessing media content items, which can potentially decrease user engagement with content provider systems.

An improved approach rooted in computer technology overcomes the foregoing and other disadvantages associated with conventional approaches specifically arising in the realm of computer technology. Based on the present technology, context information associated with a media content item accessible to a user can be determined. Access to the media content item can be provided through a content provider system, such as a social networking system. The context information can be based on various considerations that describe a context in which the media content item became known or otherwise accessible to the user. As just some examples, the context information can include a feature that indicates whether the media content item became accessible to the user via a post shared by another user, whether the media content item became accessible to the user via a message sent by another user, or whether the media content item became accessible to the user via a recommendation by the content provider system. Other types of context information are discussed in more detail herein. Based on the present technology, one or more segments of the media content item can be determined. The segments can be determined by analyzing content reflected in the media content item. Next, the segments can be scored by a machine learning model based on information about the segments and the context information. A score for a segment can indicate an extent to which the segment is of interest to the user. The scored segments can be ranked so that segments that are more likely to be of interest to the user are ranked higher than segments that are less likely to be of interest. The scored segments can also be associated with respective predicted playback speeds. For example, a segment can be associated with a 1× playback speed while another segment may be associated with a 2× playback speed. In response to a user request for the media content item, the content provider system can provide segments of the media content item out-of-order so that segments that are more likely to be of interest to the user are shown first. Further, the content provider system can provide a segment for playback at its predicted playback speed. These and other features of the present technology are discussed in further detail herein.

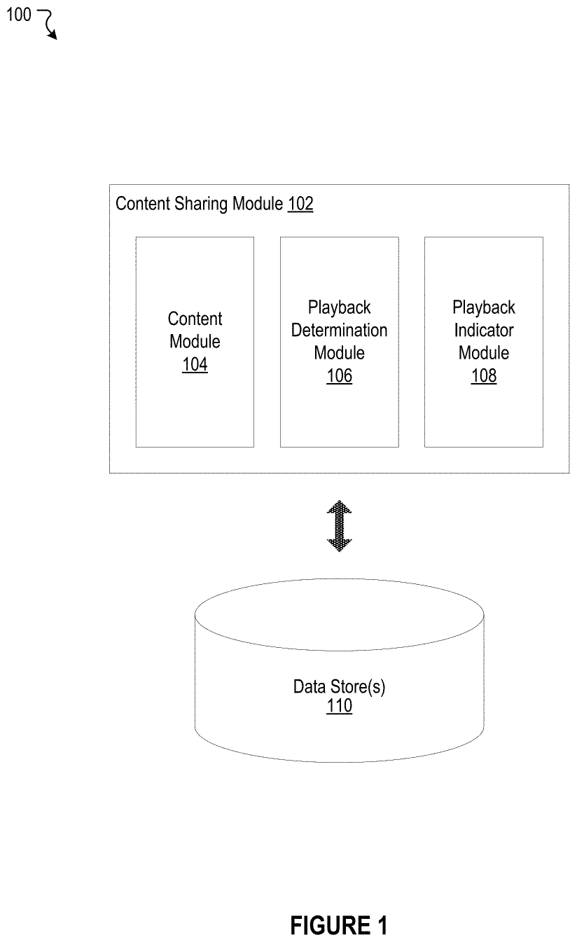

FIG. 1 illustrates an example system 100, including an example content sharing module 102, according to an embodiment of the present technology. In some embodiments, the content sharing module 102 can be implemented as whole or as part of a content provider system, such as a social networking system. As shown in FIG. 1, in some embodiments, the content sharing module 102 can include a content module 104, a playback determination module 106, and a playback indicator module 108. In some instances, the example system 100 can further include at least one data store 110. The components (e.g., modules, elements, etc.) shown in this figure and all figures herein are exemplary only, and other implementations may include additional, fewer, integrated, or different components. Some components may not be shown so as not to obscure relevant details.

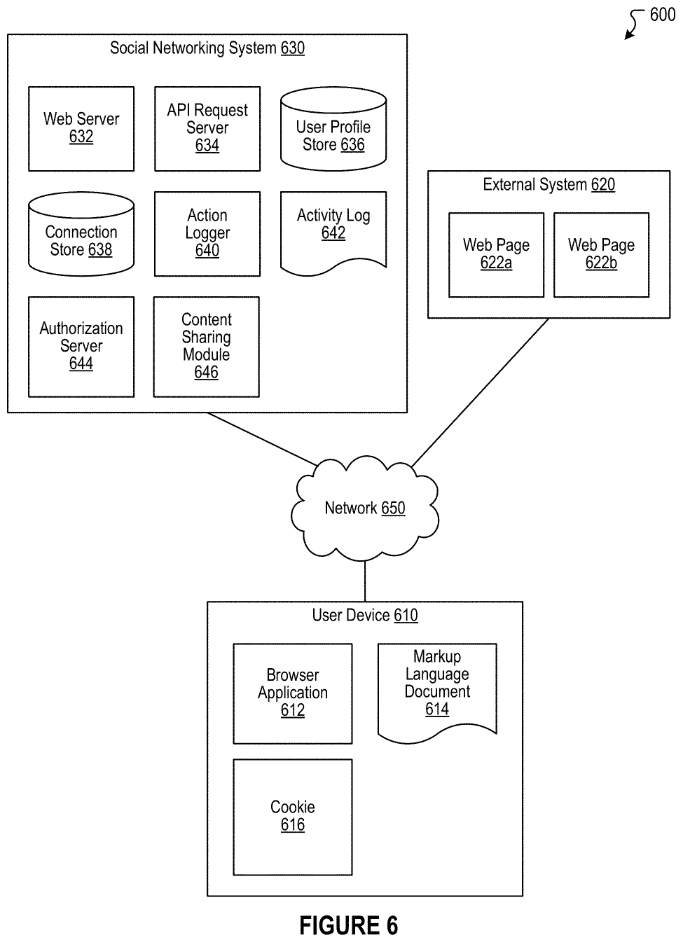

In some embodiments, the content sharing module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content sharing module 102 or at least a portion thereof can be implemented using one or more computing devices or systems that include one or more servers, such as network servers or cloud servers. In some instances, the content sharing module 102 can, in part or in whole, be implemented within or configured to operate in conjunction with a social networking system (or service), such as the social networking system 630 of FIG. 6. In some instances, the content sharing module 102 can be, in part or in whole, implemented within or configured to operate in conjunction or be integrated with a client computing device, such as the user device 610 of FIG. 6. The content sharing module 102 can be implemented as or within a dedicated application (e.g., app), a program, or an applet running on a user computing device or client computing system. The application incorporating or implementing instructions for performing some, or all, functionality of the content sharing module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

In some embodiments, the content sharing module 102 can be configured to communicate and/or operate with the at least one data store 110, as shown in the example system 100. The at least one data store 110 can be configured to store and maintain various types of data. For example, the at least one data store 110 can store information describing various content that has been viewed, accessed, consumed, modified, or created by user or third party entities of the social networking system. In some implementations, the at least one data store 110 can store information associated with the social networking system (e.g., the social networking system 630 of FIG. 6). The information associated with the social networking system can include data about users, third party entities, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users or third party entities, such as user or third party entity identifiers, user or third party entity information, profile information, user or third party entity specified settings, content produced or posted by users or third party entities, and various other types of user or third party entity data.

The content module 104 can be configured to provide options to share and access content through a content provider system (e.g., a social networking system). For example, a user can post a media content item to the content provider system. In this example, other users of the content provider system can access the media content item through, for example, their respective content feeds. The other users may be, for example, connections (or friends) of the user. In some embodiments, users can share and access media content items through a software application (or “app”). For example, in some embodiments, a software application (e.g., a messaging application, social networking application, etc.) can allow users to chat, message, communicate, and share content through the content provider system. In this example, a user can use the software application to share a media content item (or a link to the media content item) in, for example, a post or message.

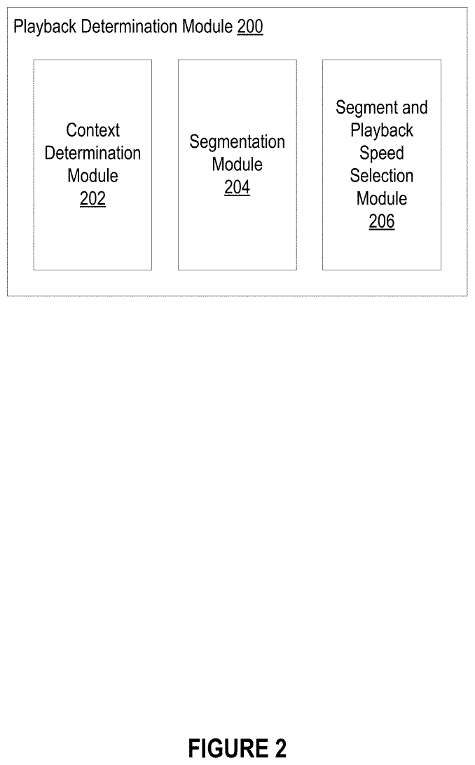

The playback determination module 106 can be configured to generate and rank segments for media content items. In general, a media content item can be divided into a number of segments. The segments can be ranked individually based on predicted interest levels of a user who desires access to the media content item. For example, a first user may wish to share a video on solving math problems, which includes a segment that focuses on Fourier transforms. The video may be shared through a chat room dedicated to a particular math class. The first user can share a link to the video in a chat message including a note “This video explains Fourier transforms well”. In this example, a second user interested in learning about Fourier transforms may seek access to the video through the chat room. The playback determination module 106 can determine context information associated with the second user. For example, the context information can indicate that the video became accessible to the second user from the chat message including the note. Further, the playback determination module 106 can divide the video into a set of segments. Based on the context information, the playback determination module 106 can determine one or more segments in the set of segments that are most likely to be of interest to the second user. In this example, the playback determination module 106 can determine that the segment of the video that discusses Fourier transforms is most likely to be of interest to the second user. As a result, the segment on Fourier transforms can be presented to the second user first before other segments are presented. The playback determination module 106 can also predict playback speeds at which to play the segments of the media content item. Playback speeds associated with segments can correspond to respective levels of user interest determined for the segments. Thus, a segment that is more likely to be of interest to a user, such as the segment on Fourier transforms, can be associated with a normal playback speed (e.g., 1×) or a slower playback speed (e.g., 0.8×, 0.5×, etc.). In contrast, a video segment that is less likely to be of interest to a user can be associated with a faster playback speed (e.g., 1.5×, 2×, etc.). The playback determination module 106 will be discussed in further detail with reference to FIG. 2.

The playback indicator module 108 can be configured to provide one or more indicators that correspond to locations of interest in a media content item. The locations can correspond to certain times or segments that have been determined to be of interest to a user. The indicators can be provided within an interface during playback of the media content item. For example, a determination can be made that a particular segment of a video is of interest to a user. Upon accessing the video, the user can be provided a media player interface that includes an indicator that corresponds to a time that marks the beginning (or beginning and end) of the segment. In another example, if two segments of a video are determined to be of threshold interest to a user, the user can be provided with two indicators within the media player interface, each indicator indicating a start of a segment determined to be of threshold interest to the user. In some embodiments, the indicators can be displayed on a progress bar provided in the media player interface during playback of the media content item. The user can interact with (or select) a given indicator to jump to a location in the media content item that is associated with the indicator. In some embodiments, a user can be automatically taken to a location of interest in a media content item when the media content item is initially accessed by the user without a need for the user to take additional action or otherwise provide additional commands to the media player interface. In this way, the present technology relieves the user from the burden of having to manually and tediously find locations of interest in a media content item, thereby greatly improving the user experience.

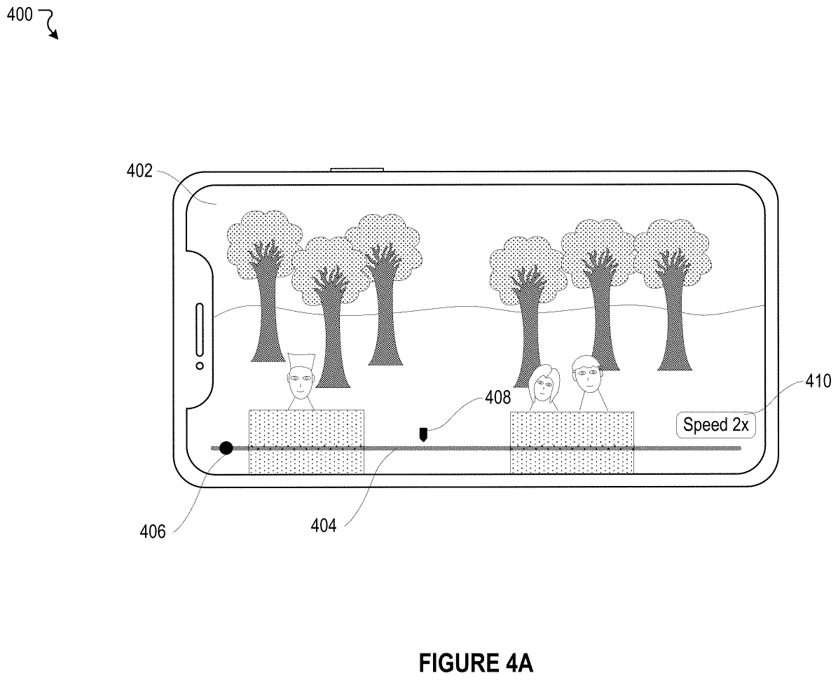

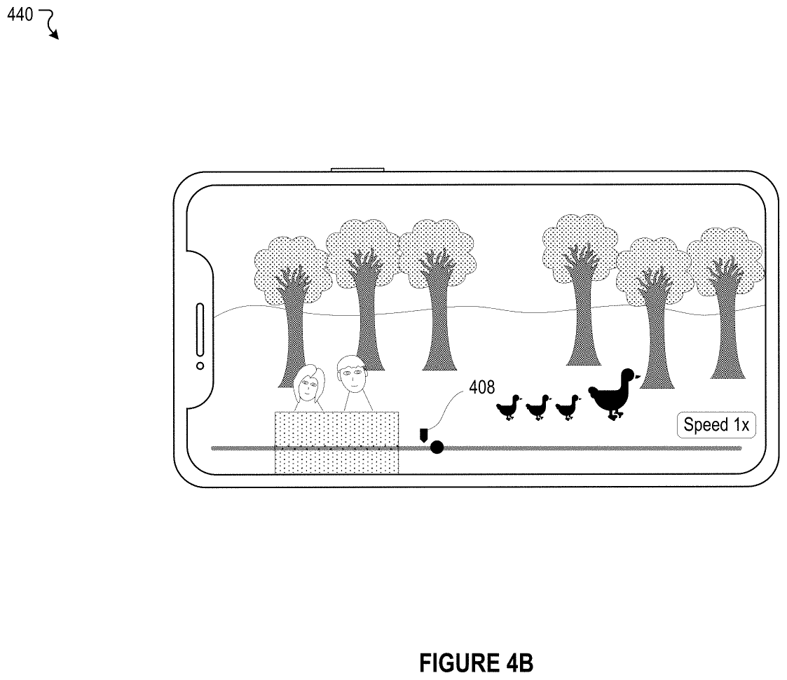

In some embodiments, the playback indicator module 108 can provide playback of a media content item at a predicted playback speed. The playback indicator module 108 also can allow a user, through a media player interface, to increase or decrease the speed of playback at a predicted playback speed. For example, a segment of a video can be initially played based on a playback speed of 2×, which can be predicted by the playback determination module 106. In this example, a user accessing the video may consider the predicted playback speed of 2× as too fast and, accordingly, may adjust the playback speed to 1.25× or some other suitable playback speed. In some embodiments, user adjustments to predicted playback speeds may be used to improve prediction of playback speeds for video segments by the playback determination module 106, as discussed in more detail herein. The playback indicator module 108 will be discussed in further detail with reference to FIGS. 4A-4B.

FIG. 2 illustrates an example playback determination module 200, according to an embodiment of the present technology. In some embodiments, the playback determination module 106 of FIG. 1 can be implemented as the playback determination module 200. As shown in FIG. 2, in some embodiments, the playback determination module 200 can include a context determination module 202, a segmentation module 204, and a segment and playback speed selection module 206.

The context determination module 202 can be configured to determine context information associated with a user seeking access to a media content item. In general, context information can describe a given context under which a user may obtain access to a media content item. For example, a video may depict a scenic lake and its surrounding forest in a first scene and a pack of wolves rummaging through the forest in a second scene. In this example, if the video is shared in a chat room dedicated to water enthusiasts, users in this chat room who access the video are more likely to be interested in the first scene. In contrast, if the same video is shared in a chat room dedicated to wolf lovers, users in this chat room are more likely to be interested in the second scene. Therefore, depending on the circumstances under which a media content item is to be accessed, different portions of the media content item may be of interest to different users. Context information can include various types of information determined by different approaches. In some embodiments, context information can include, for example, how a media content item became accessible to a user (e.g., a shared link, chat message, chat room, group, page, recommendation, etc.), labels and text associated with the media content item, a source of the media content item, utilization data associated with the media content item, and social relationship information between the user and another user that provided access to the media content item. Many variations are possible.

In some embodiments, the context determination module 202 can determine context information based on how a media content item became accessible to a user. For example, a video may be posted to a chat or content feed dedicated to dog lovers. In this example, the context determination module 202 may determine that a user that seeks to access the video through the chat or content feed is likely to be interested in video segments that correspond to dogs.

In some embodiments, the context determination module 202 can determine context information based on labels (e.g., tags, hashtags, etc.) which users associate with media content items. For example, a video relating to dogs can be shared on a page. Subsequent messages or posts by users in response to the shared video may include labels (e.g., “#HappyDog,” “#DancingPoodle”) that describe the video. In this example, the context determination module 202 may analyze the labels using natural language processing (NLP) techniques to determine that the video likely relates to dogs. Based on the labels, the context determination module 202 can further determine that a user that accesses the video may be interested in seeing video segments that correspond to dogs. Similarly, the context determination module 202 can determine context information based on a note accompanying a media content item. For example, a first user can share a link to a video with a caption “This dog is funny” in a post. The context determination module 202 can analyze the caption using natural language processing (NLP) techniques to determine that at least a portion of the video likely relates to dogs. In this example, the context determination module 202 can also determine that a second user that seeks access to the video is likely to be interested in video segments that relate to dogs.

In some embodiments, the context determination module 202 can determine context information based on a source of a media content item. For example, a video can be shared in a content provider system through a link (e.g., hyperlink, URL, etc.). In this example, the context determination module 202 can analyze the link to determine a source (or domain) associated with the video. For instance, based on analysis of the link, a determination can be made that the source of the video is a third-party video provider that specializes in cat videos. In this instance, context determination module 202 can determine that a user that seeks to access the video may be interested in seeing video segments that correspond to cats.

In some embodiments, the context determination module 202 can determine context information based on utilization data associated with a media content item. Utilization data of a media content item can include, for example, information relating to portions (or segments) of the media content item that were accessed by users and respective playback speeds of the portions. The playback speed of a portion of a video can indicate a user interest level in the portion. For example, a relatively higher playback speed can indicate a relatively lower level of user interest and a relatively slower playback speed can indicate a relatively higher level of user interest. The utilization data can be aggregated by a content provider system. For instance, a 5-minute long video can be shared numerous times through a content provider system. Based on utilization data aggregated by the content provider system, the context determination module 202 may determine that most users viewed this video between a start time and an elapsed time of 2 minutes at a playback speed of 1.5×, between the elapsed time of 2 minutes and an elapsed time of 3 minutes at a playback speed of 1×, and skipped playback of the rest of the video. In this instance, the context determination module 202 may determine that a segment of the video including the portion between the elapsed time of 2 minutes and the elapsed time of 3 minutes may be of most interest to users accessing the video.

The segmentation module 204 can be configured to divide a media content item into one or more segments. A segment can be of any length and may be associated with a particular object, scene, environment, concept, and/or theme reflected in the media content item. In some embodiments, the segmentation module 204 can use various object recognition techniques to generate segments for a media content item. For example, the segmentation module 204 can apply objection recognition techniques to identify objects, scenes, environments, concepts, and/or themes reflected in the media content item. In this example, the segmentation module 204 can segment the media content item into segments based on the identified objects, scenes, environments, concepts, and/or themes. In some embodiments, the segmentation module 204 can segment a media content item based on transitions. For example, a video can include long pauses or transition music that can demarcate various segments in the video. In this example, the segmentation module 204 can identify the long pauses or transition music and use these as signals to inform video segmentation. In some embodiments, the segmentation module 204 can use NLP to analyze a media content item for transitions. For example, the segmentation module 204 can use NLP to detect keywords that appear as text in a media content item, such as “introduction,” “title,” “summary,” or “conclusion”. In this example, detected keywords can be used as signals to inform video segmentation. In some cases, the segmentation module 204 can apply voice recognition techniques to detect audio-based utterances of keywords, which also can be used as signals to inform video segmentation. Many variations are possible.

In some embodiments, the segmentation module 204 can classify one or more segments of a media content item based on a machine learning classifier. The machine learning classifier can be any suitable classifier, such as a classifier or model based on linear regression or logistical regression. For example, a video can include a first scene reflecting people picnicking at a park and a second scene reflecting ducklings walking through the park. In this example, in addition to segmenting the video into a first video segment and a second video segment, the segmentation module 204 can further determine, based on the classifier, that the first video segment corresponds to a “picnic” category and a “park” category while the second video segment corresponds to a “duck” category and the “park” category. This classification information can be used to select one or more segments of a media content item that are relevant to a user who seeks access to the media content item.

The segment and playback speed selection module 206 can be configured to determine one or more segments of a media content item that are likely to be of interest to a user. The segment and playback speed selection module 206 can implement one or more machine learning models to determine segments that are of interest to the user. In some embodiments, a machine learning model can evaluate context information and information describing segments of the media content item as inputs to determine the segments that are of interest to the user. The machine learning model can be trained with various training data, such as context information and classifications of video segments discussed herein along with labels that reflect historical user viewing interest and preferences in the segments as maintained by a content provider system. For example, the training data can include strong signals, such as watch time of video segments (e.g., whether a user watched a threshold amount of time, whether a user watched for only one second and stopped watching, etc.), a number of times a user repeated watching a video segment, a number of users who repeated watching a video segment, and the like. In some embodiments, features of an input feature vector(s) can include the context information and the classification of video segments described herein. The input feature vector can be provided to the machine learning model, and the machine learning model can determine the one or more segments that are of interest to the user.

In some embodiments, the segment and playback speed selection module 206 can score video segments. For example, a segment can be scored by the machine learning model. A score can indicate a user interest in a segment. As just one example, the machine learning model can output a score that ranges from a scale of 1 to 5 for each segment of a media content item, with 1 being least interesting and 5 being most interesting. In some cases, the machine learning model can output, for each segment, a binary score, with 0 indicating a segment that is not interesting and 1 indicating a segment that is interesting. Many variations are possible. In some embodiments, the machine learning model can be configured to further output a confidence score for a score about user interest determined for a given segment. A confidence score can indicate a confidence level of the machine learning model in predicting a score about user interest for a segment of a media content item. In general, the higher the confidence score for a given score about user interest, the higher the confidence level of the machine learning model in predicting the score about user interest.

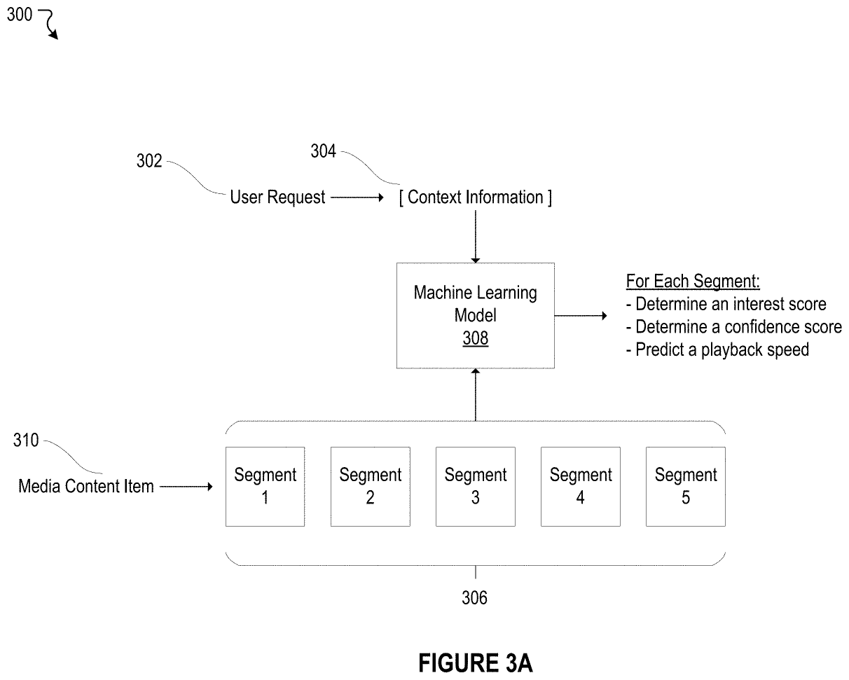

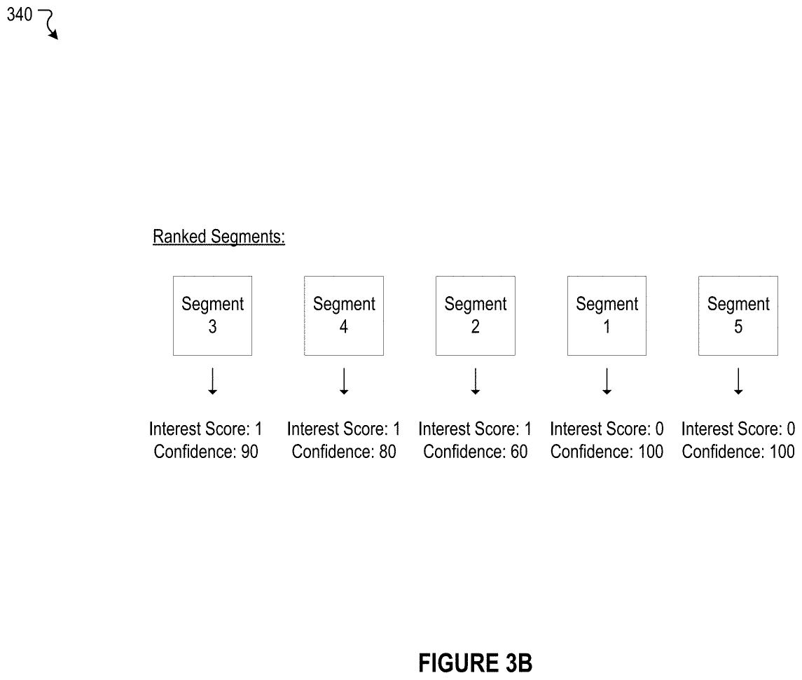

The segment and playback speed selection module 206 can also rank segments of a media content item based on scores determined for the segments. The ranking of the segments can be used to determine an order for playing the segments of the media content item. A highest ranking segment for a given user can be played out-of-order before other segments. For example, a video comprising three segments can be accessed by a user. In this example, the segment and playback speed selection module 206 can output binary scores of 0, 1, and 1, respectively, for the three segments, where 0 indicates a segment is predicted to be not interesting to the user and where 1 indicates a segment is predicted to be interesting to the user. The segment and playback speed selection module 206 can further output confidence scores of 100, 50, and 100, respectively, for each of the three segments. In this example, based on the confidence scores, the segment and playback speed selection module 206 can determine that the third segment with a score about user interest of 1 and a confidence score of 100 is most likely to be of interest to the user. In this example, although the segment and playback speed selection module 206 determined a score of 1 to both the second segment and the third segment, the third segment is ranked higher because the confidence score for the third segment is higher than the confidence score for the second segment. Ranking of segments of a media content item based on confidence scores will be discussed in further detail with reference to FIGS. 3A-3B.

The segment and playback speed selection module 206 can predict playback speeds at which to play segments of a media content item. In some embodiments, the segment and playback speed selection module 206 can implement one or more machine learning models to predict a playback speed at which to play a segment for a user. For example, a machine learning model can evaluate information associated with a segment and context information to predict a playback speed at which to play the segment for a user. A predicted playback speed for a segment generally corresponds to a level of user interest determined for that segment. Hence, segments that are of interest to users can be played at normal (or slower) speeds (e.g., at 1×, 0.5×, etc.), while segments that are of little or no interest to the users can be played at faster playback speeds (e.g., 1.25×, 1.5×, 2×, etc.). In some embodiments, playback speeds at which to play a segment of a video can be determined based on the nature or type of the segment or the video. For example, a segment reflecting a certain theme or subject matter may be optimally played at a certain corresponding playback speed(s). Likewise, other playback speeds may be suboptimal for the segment. Statistics or aggregated data relating to historical playback speeds chosen by users for various types of video segments can be used to select playback speeds for video segments of various types. In some embodiments, the segment and playback speed selection module 206 can train and retrain machine learning models to predict playback speeds for segments of media content items based on playback speeds at which users of a content provider system previously played segments of a media content item or adjusted predicted playback speeds of segments of a media content item.

FIG. 3A illustrates an example functional block diagram 300, according to an embodiment of the present technology. In some embodiments, functionalities described in the functional block diagram 300 can be supported by the playback determination module 200 of FIG. 2. In various embodiments, upon receiving a user request 302 to access a media content item 310, features 304 associated with context information can be generated. The features 304 associated with context information can include the various context information discussed herein. Content of the media content item 310 can be analyzed as described herein to determine transitions in the media content item 310. The media content item 310 can be divided into segments 306 based on the transitions. The segments 306 can be classified into categories. The features 304 associated with context information and the segments 306, along with their classifications, can be inputted to a machine learning model 308 to determine an interest score, a confidence score, and a predicted playback speed for each of the segments 306. For example, as shown in the functional block diagram 300 of FIG. 3A, the segments 306 comprise five segments. In this example, the machine learning model 308 can determine an interest score, a confidence score, and a predicted playback speed for each of the five segments. For instance, for the segments 306, the machine learning model 308 may determine interest scores, confidence scores, and predicted playback speeds as follows:

| | Interest | Confidence | Playback |
|---|---|---|---|
| Segment | Score | Score | Speed |
| Segment 1 | 0 | 100 | 2× |
| Segment 2 | 1 | 60 | 1.5× |
| Segment 3 | 1 | 90 | 1× |
| Segment 4 | 1 | 80 | 1× |
| Segment 5 | 0 | 100 | 2× |

In this instance, an interest score of 1 indicates a segment is of interest to the user whereas an interest score of 0 indicates a segment is not of interest to the user. In this instance, a confidence score of 100 indicates the machine learning model 308 is most confident in its determination of a score whereas a confidence score of 0 indicates the machine learning model 308 is least confident in its determination of a score. A predicted playback speed can be used to play a segment at a playback speed that may be different than a playback speed that was originally intended for the segment. As shown in the table above, in this instance, the machine learning model 308 has determined that Segments 2, 3, and 4 are of interest to the user with confidence scores of 60, 90, and 80, respectively, and with predicted playback speeds of 1.5×, 1×, and 1×, respectively. The machine learning model 308 has determined that Segments 1 and 5 are of no interest to the user with a confidence score of 100 and with a predicted playback speed of 2×.

FIG. 3B illustrates another example functional block diagram 340, according to an embodiment of the present technology. The functional block diagram 340 relates to the example of the functional block diagram 300 of FIG. 3A. After the machine learning module 308 outputs the interest scores and the confidence scores of the segments 306, the segments 306 can be ranked based on their confidence scores. For example, as shown in FIG. 3B, Segments 2, 3, and 4 are of interest to the user because these segments have an interest score of 1. Segments 2, 3, and 4 are ranked based on their confidence scores. In this case, Segment 3 is ranked first because Segment 3 has the highest confidence score, followed by Segment 4, and then followed by Segment 2. Thus, in this example, Segment 3 can be provided for presentation to the user first at the predicted playback speed of 1×, Segment 4 can be presented next at the predicted playback speed of 1×, followed by Segment 2 at the predicted playback speed of 1.5×. Many variations are possible.

FIGS. 4A-4B illustrate example diagrams 400, 440, according to an embodiment of the present technology. The example diagram 400 of FIG. 4A depicts a scenario in which a first user of a content provider system shares a link to a media content item (e.g., a video) with a second user of the content provider system. The link to the media content item can be shared through a software application provided by the content provider system. As depicted in the diagram 400, when the second user accesses the media content item through the link, the second user is provided a media player interface 402 through which the media content item is played. The media player interface 402 can include a progress bar 404, a progress indicator 406, and an optimal playback location indicator 408. The progress bar 404 can indicate an overall length of the media content item. The progress indicator 406 can indicate a current playback location in the media content item. The optimal playback location indicator 408 can indicate a playback location that is determined to be of most interest to the second user. For example, the optimal playback location indicator 408 can correspond to the beginning of a segment that is determined to be of most interest to the second user using the techniques described herein. Upon selection of the optimal playback location indicator 408, the second user is taken (jumped) to the playback location that is determined to be of most interest. In various embodiments, additional optimal playback location indicators that correspond to additional segments determined to be of interest to the second user can be provided in the media player interface 402. In some cases, the media player interface 402 can further include a window 410. The window 410 can indicate a predicted playback speed at which the media content item is currently playing at the current playback location.

The example diagram 440 of FIG. 4B depicts a scenario in which it has been determined that the second user is interested in ducklings based on context information and classification of segments of the media content item. Therefore, in this scenario, the optimal playback location indicator 408 indicates a playback location in the media content item that corresponds to a segment of the media content item relating to ducklings. The second user has selected the optimal playback location indicator 408 and has been taken to the associated playback location that is of interest. In some cases, upon accessing the media content item, the second user can be directly taken to the playback location indicated by the optimal playback location indicator 408 without selection of the optimal playback location indicator 408 by the second user.

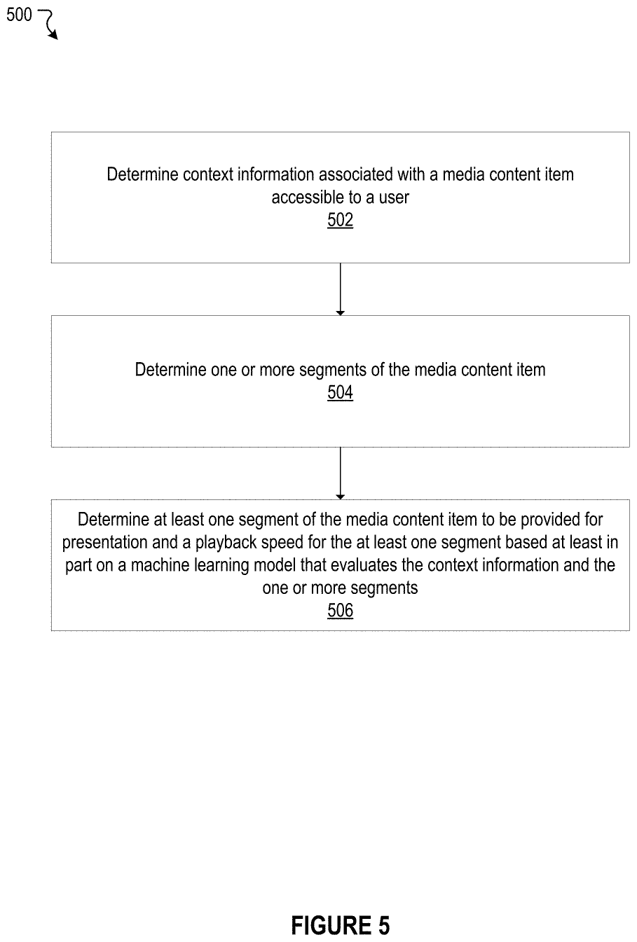

FIG. 5 illustrates an example method, according to an embodiment of the present technology. It should be appreciated that there can be additional, fewer, or alternative steps performed in similar or alternative orders, or in parallel, within the scope of the various embodiments discussed herein unless otherwise stated.

At block 502, context information associated with a media content item can be determined. At block 504, one or more segments of the media content item can be determined. At block 506, at least one segment of the media content item to be provided for presentation and a playback speed for the at least one segment can be determined. The at least one segment and the playback speed can be determined based at least in part on a machine learning model that evaluates the context information and the one or more segments.

It is contemplated that there can be many other uses, applications, and/or variations associated with the various embodiments of the present technology. For example, in some cases, user can choose whether or not to opt-in to utilize the disclosed technology. The disclosed technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, media content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and media content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content sharing module 646. The content sharing module 646 can be implemented with the content sharing module 102 of FIG. 1. In some embodiments, one or more functionalities of the content sharing module 646 can also be implemented in the user device 610.

### Hardware Implementation

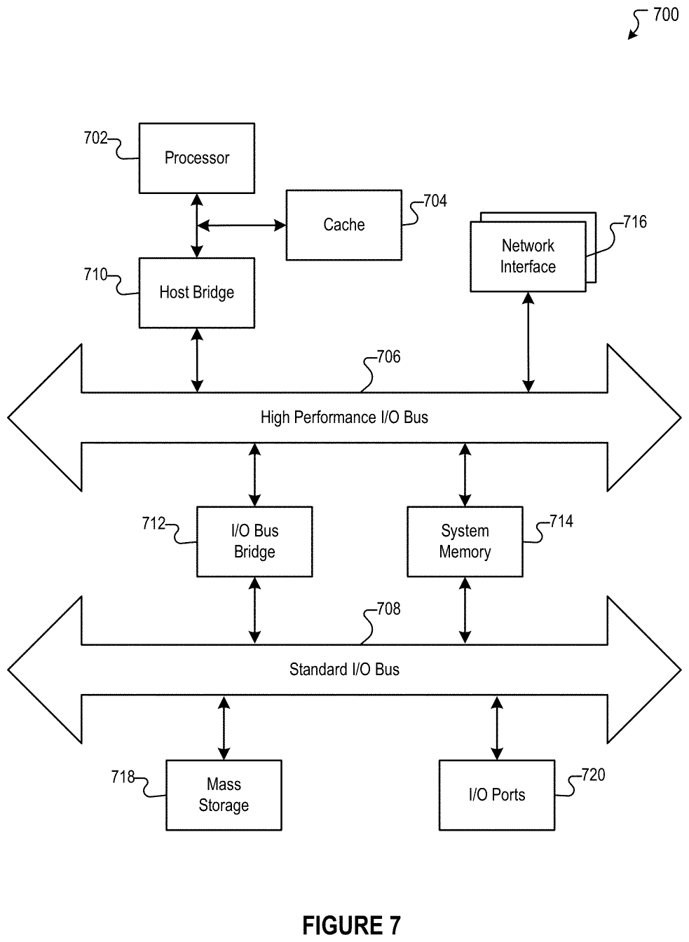

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and 1/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, context information associated with a media content item accessible to a user;
determining, by the computing system, one or more segments of the media content item;
training, by the computing system, a machine learning model to determine segments of media content items and associated playback speeds, wherein training data for the machine learning model includes the context information, the context information associated with contexts through which media content items were made accessible to users; and
determining, by the computing system, a plurality of segments of the media content item to be provided for presentation and a playback speed for each of the plurality of segments based at least in part on the machine learning model, wherein the determining the plurality of segments comprises:
ranking, by the computing system, the plurality of segments, wherein in response to a user request to access the media content item a first portion of the plurality of segments are presented out of order according to their ranking.

2. The computer-implemented method of claim 1, wherein the machine learning model outputs a score, a confidence score, and a playback speed for each segment of the one or more segments.

3. The computer-implemented method of claim 2, wherein the ranking the plurality of segments comprises:
ranking, by the computing system, the one or more segments based on their respective scores and confidence scores.

4. The computer-implemented method of claim 1, further comprising:
providing, by the computing system, during playback of the media content item, an indicator indicating a playback location associated with a segment of the plurality of segments; and
transitioning, by the computing system, in response to a user interaction, the playback of the media content item to the playback location indicated by the indicator.

5. The computer-implemented method of claim 1, further comprising:
providing, by the computing system, the media content item for presentation to the user at a playback location corresponding to a segment of the plurality of segments.

6. The computer-implemented method of claim 1, wherein the one or more segments are determined based on at least one of objects, scenes, environments, concepts, or themes depicted in the media content item.

7. The computer-implemented method of claim 1, wherein the one or more segments are determined based on keywords or pauses in the media content item.

8. The computer-implemented method of claim 1, wherein the context information is determined based a source of the media content item.

9. The computer-implemented method of claim 1, wherein the context information is determined based on chats or content feeds from which the media content item is accessible to the user.

10. The computer-implemented method of claim 1, wherein the playback speed is determined based in part on playback speeds at which other users previously played segments of the media content item.

11. A computing system comprising:
at least one processor; and
a memory storing instructions that, when executed by the at least one processor, cause the computing system to perform a method comprising:
determining context information associated with a media content item accessible to a user;
determining one or more segments of the media content item;
training a machine learning model to determine segments of media content items and associated playback speeds, wherein training data for the machine learning model includes the context information, the context information associated with contexts through which media content items were made accessible to users; and
determining a plurality of segments of the media content item to be provided for presentation and a playback speed for each of the plurality of segments based at least in part on the machine learning model, wherein the determining the plurality of segments comprises:
ranking the plurality of segments, wherein in response to a user request to access the media content item a first portion of the plurality of segments are presented out of order according to their ranking.

12. The computing system of claim 11, wherein the machine learning model outputs a score, a confidence score, and a playback speed for each segment of the one or more segments.

13. The computing system of claim 12, wherein the ranking the plurality of segments comprises:
ranking the one or more segments based on their respective scores and confidence scores.

14. The computing system of claim 11, wherein the instructions, when executed, further causes the computing system to perform:
providing, during playback of the media content item, an indicator indicating a playback location associated with a segment of the plurality of segments; and
transitioning, in response to a user interaction, the playback of the media content item to the playback location indicated by the indicator.

15. The computing system of claim 11, wherein the instructions, when executed, further causes the computing system to perform:
providing the media content item for presentation to the user at a playback location corresponding to a segment of the plurality of segments.

16. A non-transitory computer-readable storage medium including instructions that, when executed by at least one processor of a computing system, cause the computing system to perform a method comprising:
determining context information associated with a media content item accessible to a user;
determining one or more segments of the media content item;
training a machine learning model to determine segments of media content items and associated playback speeds, wherein training data for the machine learning model includes the context information, the context information associated with contexts through which media content items were made accessible to users; and
determining a plurality of segments of the media content item to be provided for presentation and a playback speed for each of the plurality of segments based at least in part on the machine learning model, wherein the determining the plurality of segments comprises:
ranking the plurality of segments, wherein in response to a user request to access the media content item a first portion of the plurality of segments are presented out of order according to their ranking.

17. The non-transitory computer-readable storage medium of claim 16, wherein the machine learning model outputs a score, a confidence score, and a playback speed for each segment of the one or more segments.

18. The non-transitory computer-readable storage medium of claim 17, wherein the ranking the plurality of segments comprises:
ranking the one or more segments based on their respective confidence scores and scores.

19. The non-transitory computer-readable storage medium of claim 16, wherein the instructions, when executed, further causes the computing system to perform:
providing, during playback of the media content item, an indicator indicating a playback location associated with a segment of the plurality of segments; and
transitioning, in response to a user interaction, the playback of the media content item to the playback location indicated by the indicator.

20. (canceled)

21. The computer-implemented method of claim 1, wherein the contexts comprise a post, a message, and a recommendation by a content provider system.
